(19) United States
(12) Patent Application Publication
(10) Pub. No.: US 2018/0207777 A1
(43) Pub. Date: Jul. 26, 2018

(54) POWERED FASTENER DRIVER

(71) Applicant: TTI (MACAO COMMERCIAL OFFSHORE) LIMITED, Macao (MO)

(72) Inventors: Reid Cheatham, Greenville, SC (US); Matthew Conner, Greenville, SC (US)

(21) Appl. No.: 15/924,558

(22) Filed: Mar. 19, 2018

Related U.S. Application Data
(63) Continuation-in-part of application No. 15/641,459, filed on Jul. 5, 2017.
(60) Provisional application No. 62/358,944, filed on Jul. 6, 2016.

(51) Int. Cl. B25C 1/00; B25C 1/04

(52) U.S. Cl. CPC B25C 1/008; B25C 1/047

(57) ABSTRACT

A powered fastener driver includes a magazine containing fasteners therein, a drive blade movable in a reciprocating manner to discharge a fastener from the magazine for each drive cycle of the drive blade, a first trigger operable to initiate a drive cycle of the drive blade, and a second trigger movable between a first position, in which initiation of the drive cycle is inhibited irrespective of actuation of the first trigger, and a second position, in which initiation of the drive cycle occurs in conjunction with actuation of the first trigger.

### CROSS-REFERENCE TO RELATED APPLICATIONS

This application is a continuation-in-part of co-pending U.S. patent application Ser. No. 15/641,459 filed Jul. 5, 2017, which claims priority to U.S. Provisional Patent Application No. 62/358,944 filed Jul. 6, 2016, the entire contents of which are incorporated herein by reference.

### FIELD OF THE INVENTION

The present invention relates to a power tool, and more particularly to a powered fastener driver.

### BACKGROUND OF THE INVENTION

There are various fastener drivers used to drive fasteners (e.g., nails, tacks, staples, etc.) into a workpiece known in the art. These fastener drivers operate utilizing various means (e.g., compressed air generated by an air compressor, electrical energy, flywheel mechanisms) known in the art, but often these designs are met with power, size, and cost constraints.

### SUMMARY OF THE INVENTION

The invention provides, in one aspect, a powered fastener driver includes a magazine containing fasteners therein, a drive blade movable in a reciprocating manner to discharge a fastener from the magazine for each drive cycle of the drive blade, a first trigger operable to initiate a drive cycle of the drive blade, and a second trigger movable between a first position, in which initiation of the drive cycle is inhibited irrespective of actuation of the first trigger, and a second position, in which initiation of the drive cycle occurs in conjunction with actuation of the first trigger.

The invention provides, in another aspect, a method of operating a powered fastener driver. The method includes providing a first trigger operable to initiate a drive cycle of a drive blade of the fastener driver, actuating a second trigger from a first position to a second position, and then actuating the first trigger to initiate the drive cycle of the drive blade.

Other features and aspects of the invention will become apparent by consideration of the following detailed description and accompanying drawings.

### BRIEF DESCRIPTION OF THE DRAWINGS

FIG. 1 is a side view of a powered fastener driver in accordance with an embodiment of the invention.

FIG. 2 is an enlarged perspective view of a portion of the powered fastener driver of FIG. 1.

FIG. 3 is a side view of the powered fastener driver of FIG. 1, illustrating a linkage extending between an activation trigger and a safety trigger of the fastener driver, with the safety trigger in a locked position.

FIG. 4 is a side view of the powered fastener driver of FIG. 1, illustrating the safety trigger in a released position.

FIG. 5 is a side view of the powered fastener driver of FIG. 1, illustrating movement of the linkage in response to actuation of the activation trigger, with the safety trigger in the released position.

FIG. 6 is a partial side view of a powered fastener driver in accordance with another embodiment of the invention, illustrating a linkage extending between an activation trigger and a safety trigger of the fastener driver, with the safety trigger in an unlocked position.

FIG. 7A is an exploded cross-sectional view of a trigger valve of the activation trigger of FIG. 6.

FIG. 7B is a cross-sectional view of the trigger valve in a default position and the linkage in an unactuated position.

FIG. 7C is a cross-sectional view of the trigger valve in a depressed position and the linkage in an actuated position.

FIG. 7D is a cross-sectional view of the trigger valve in a depressed position and the linkage in the actuated position.

FIG. 8 is a partial side view of a powered fastener driver in accordance with yet another embodiment of the invention, illustrating a safety valve coupled for movement with a safety trigger of the fastener driver, with the safety trigger in an unlocked position.

FIG. 9 is a partial side view of a powered fastener driver in accordance with another embodiment of the invention, illustrating a safety switch electrically connected to a safety trigger of the fastener driver.

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

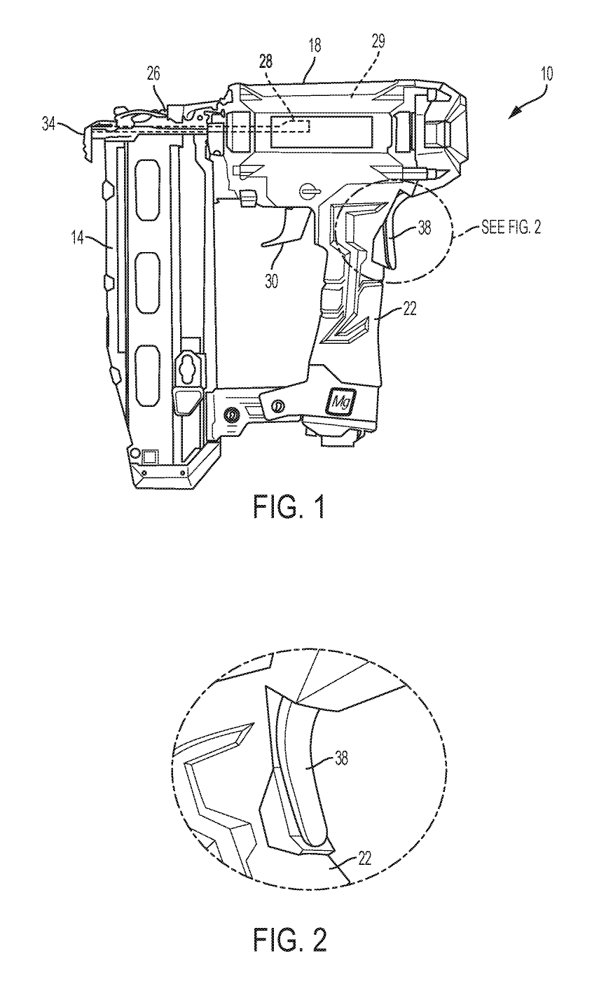

With reference to FIG. 1, a fastener driver 10 is operable to drive fasteners (e.g., nails, tacks, staples, etc.) held within a magazine 14 into a workpiece. The fastener driver 10 includes a housing 18 with a handle portion 22, a nosepiece 26 extending from the housing 18 from which the fasteners are ejected, and a drive blade 28 movable in a reciprocating manner within the nosepiece 26 for discharging the fasteners from the magazine 14. The fastener driver 10 also includes a drive mechanism 29 disposed within the housing 18 for reciprocating the drive blade 28 through consecutive drive cycles, for each one of which a single fastener is discharged from the magazine 14 at the nosepiece 26 and driven into a workpiece. In some embodiments, the drive mechanism 29 includes an on-board air compressor that generates pressurized air for applying a force to drive the blade 28 via a head valve (not shown). In other embodiments, the drive mechanism 29 may include a compression spring or a gas spring for applying a force on the drive blade 28. In yet other embodiments, the drive mechanism 29 may include a remote power source (e.g., an external source of pressurized air) for applying a force on the drive blade 28.

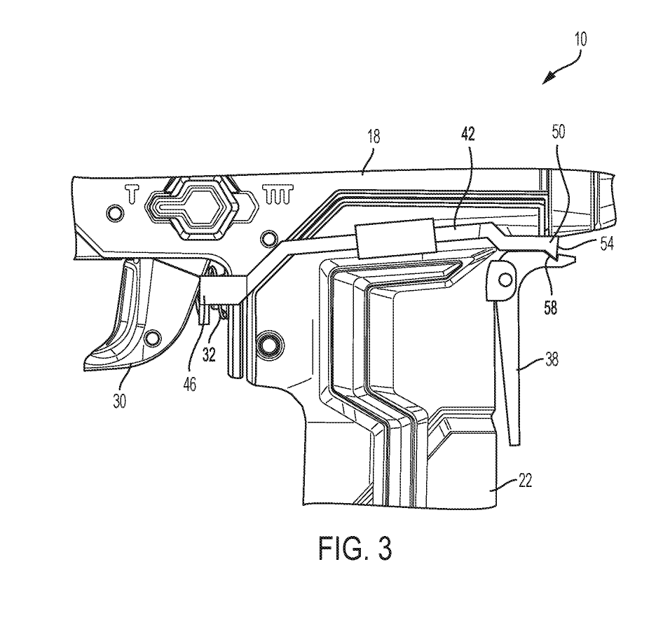

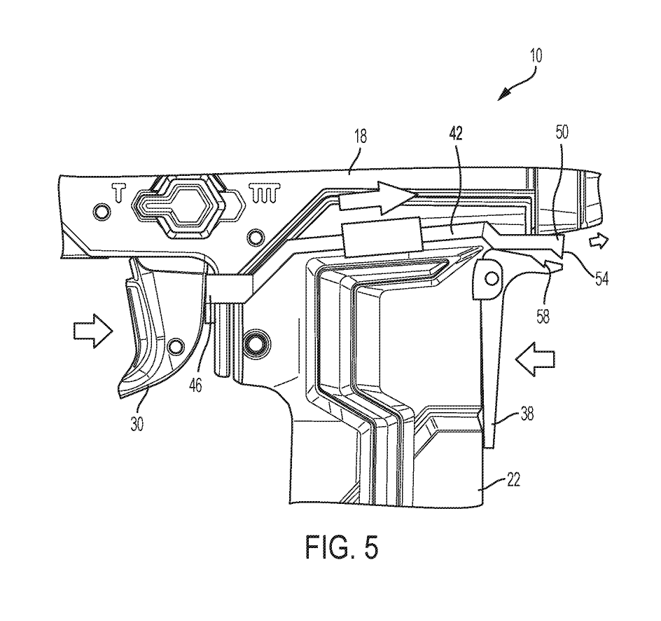

The fastener driver 10 further includes a first or activation trigger 30 disposed adjacent the handle portion 22 that is user-actuated to begin each drive cycle and a contact arm 34 slidable relative to the nosepiece 26 in response to contacting a workpiece. Specifically, trigger 30 is movable from a default position (FIG. 3) to a depressed position (FIG. 5) to initiate the drive cycle. The activation trigger 30 is biased toward the default position by a biasing element, such as a spring 32 (FIG. 3). Also, the contact arm 34 is movable between a biased, extended position in which fasteners are inhibited from being discharged from the magazine 14, and a retracted position in which fasteners are permitted to be discharged from the magazine 14. In some embodiments, the contact arm 34 mechanically interfaces with the activation trigger 30 to selectively permit a drive cycle to be initiated. In other embodiments, the contact arm 34 may electrically interface with a master controller which, in turn, is electrically connected with the activation trigger 30 to selectively permit a drive cycle to be initiated. In such an embodiment, the master controller is operable to accept a trigger input from the activation trigger 30 and a contact arm input from the contact arm 34. Both the trigger input and the contact arm input may be provided by sensors, switches, or other electrical and/or electromechanical components. Upon detecting both the contact arm input and the trigger input, the master controller may initiate a drive cycle.

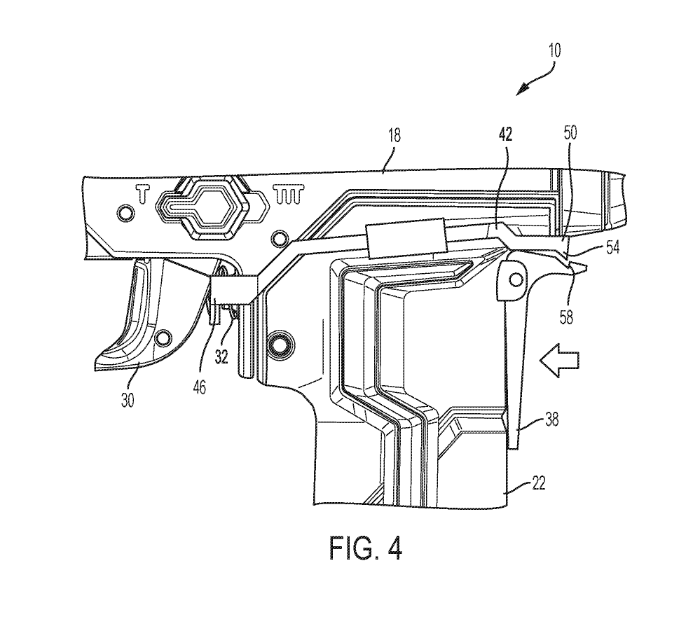

With reference to FIGS. 1 and 2, the fastener driver 10 further includes a second or safety trigger 38 disposed adjacent the handle portion 22 on an opposite side as the activation trigger 30. While the activation trigger 30 is actuated toward the depressed position by the user's fingers, the safety trigger 38 is actuated toward a depressed position (FIG. 4) by the web of the user's hand (e.g., the interdigital skin fold between the thumb and the forefinger) as the user grasps the handle portion 22. In other words, in the illustrated embodiment of the fastener driver 10, the activation trigger 30 is disposed on the front of the handle portion 22, while the safety trigger 38 is disposed on the rear of the handle portion 22 (from the frame of reference of FIG. 1). The fastener driver 10 also includes a biasing element (e.g., a spring, not shown) for biasing the safety trigger 38 toward a default locked position as shown in FIG. 3.

With reference to FIGS. 3-5, the fastener driver 10 also includes a linkage 42 supported by the housing 18 and extending between the activation trigger 30 and the safety trigger 38. Although the linkage 42 is schematically illustrated as being positioned on the exterior of the housing 18 in FIGS. 3-5, the linkage 42 is positioned internally of the housing 18 as shown in FIG. 1. The linkage 42 inhibits movement of (i.e., “locks out”) the activation trigger 30 when the safety trigger 38 is in the locked position (FIG. 3). However, when the safety trigger 38 is moved to the released position, it no longer interferes with the linkage 42 (FIG. 4), permitting the activation trigger 30 to be depressed (FIG. 5).

The linkage 42 includes a first end 46 adjacent the activation trigger 30 and an opposite, second end 50 adjacent the safety trigger 38. The first end 46 is maintained in sliding contact with activation trigger 30 by the spring 32, whereas the second end 50 includes a protrusion 54 that is selectively receivable in a corresponding recess 58 of the safety trigger 38. Specifically, the protrusion 54 is received within the recess 58 when the safety trigger 38 is in the locked position (FIG. 3), which causes the linkage 42 to interfere with actuation of the activation trigger 30. When the protrusion 54 is removed from the recess 58 in response to the safety trigger 38 being pivoted from the locked position (FIG. 3) to the released position (FIG. 4), the linkage 42 is moveable relative to the safety trigger 38 in response to actuation of the activation trigger 30. Although not shown in FIGS. 3-5, the linkage 42 is supported within the housing 18 for translation relative to the housing 18. Accordingly, the second end 50 of the linkage 42 is slidable relative to the safety trigger 38 when the safety trigger 38 is in the released position. In the illustrated embodiment, the linkage 42 is movable in unison with and in response to pivoting movement of the activation trigger 30. In other embodiments, instead of a mechanical linkage 42, the fastener driver 10 may include an electronic linkage between the safety trigger 38 and the activation trigger 30 for selectively permitting actuation of the activation trigger 30. In such an embodiment, both of the triggers 30, 38 would be configured as electrical switches connected with a controller onboard the fastener driver 10, with the safety trigger 38 providing an input signal to the controller upon being depressed by the user to thereby permit initiation of a drive cycle in response to the user depressing the activation trigger 30. Without first receiving the input signal from the safety trigger 38, the controller will not enable the activation trigger 30.

In one manner of operation of the fastener driver 10 (known as single sequential mode), while concurrently pressing the safety trigger 38 and grasping the handle portion 22 with the same hand, an operator first presses the contact arm 34 against a workpiece, causing it to retract, and then presses the activation trigger 30 to initiate a drive cycle for discharging a fastener from the magazine 14. Upon pressing the safety trigger 38, the protrusion 54 is removed from the recess 58, releasing the lockout of the activation trigger 30. Thereafter, the linkage 42 is movable in unison with pivoting movement of the activation trigger 30 in response to the operator depressing the activation trigger 30. The linkage 42 moves concurrently each time the activation trigger 30 is pressed, such that the protrusion 54 moves relative to the recess 58 of the safety trigger 38. If the safety trigger 38 is not first pressed, the protrusion 54 interferes with the safety trigger 38 and the linkage 42 will lockout the activation trigger 30, preventing it from being pressed.

In another manner of operation of the fastener driver 10 (known as bump-fire mode), an operator first actuates the safety trigger 38 from the locked position to the released position, thereby releasing the lockout of the activation trigger 30. Thereafter, a drive cycle is initiated each time the contact arm 34 is retracted coinciding with being depressed against a workpiece.

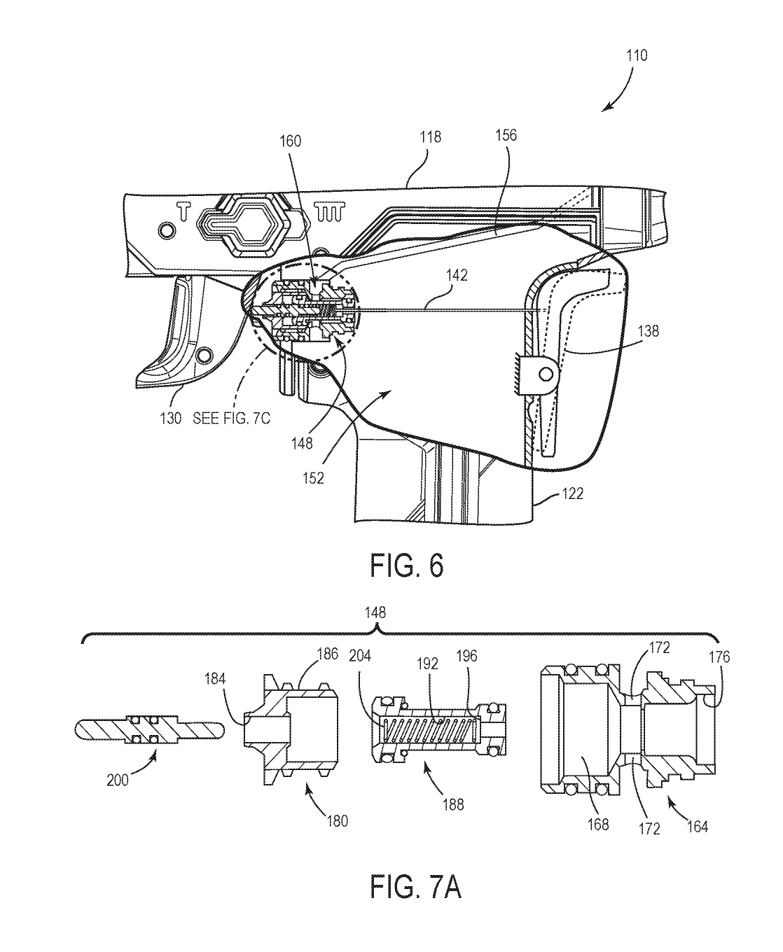

FIG. 6 illustrates a fastener driver 110 in accordance with another embodiment of the invention. The fastener driver 110 includes a linkage 142 movably coupled to a safety trigger 138 and is operable to inhibit a drive cycle, but is otherwise similar to the fastener driver 10 described above with reference to FIGS. 1-5, with like components being shown with like reference numerals plus 100. Differences between the fastener driver 10, 110 are described below.

The fastener driver 110 includes a housing 118 with a handle portion 122, a first or activation trigger 130, and a second or safety trigger 138. The activation trigger 130 and the safety trigger 138 are disposed adjacent and on opposite sides of the handle portion 122. Specifically, the activation trigger 130 is disposed on the front of the handle portion 122, while the safety trigger 138 is disposed on the rear of the handle portion 122. The activation trigger 130 is user-actuated to begin each drive cycle between a default position (FIG. 6) and a depressed position (not shown) to initiate the drive cycle. While the activation trigger 130 is actuated toward the depressed position by the user's fingers, the safety trigger 138 is actuated toward a depressed position (as shown in solid lines in FIG. 6) by the web of the user's hand as the user grasps the handle portion 122. The fastener driver 110 also includes a biasing element (e.g., a spring, not shown) for biasing the safety trigger 138 toward a default position (as shown in phantom lines in FIG. 6).

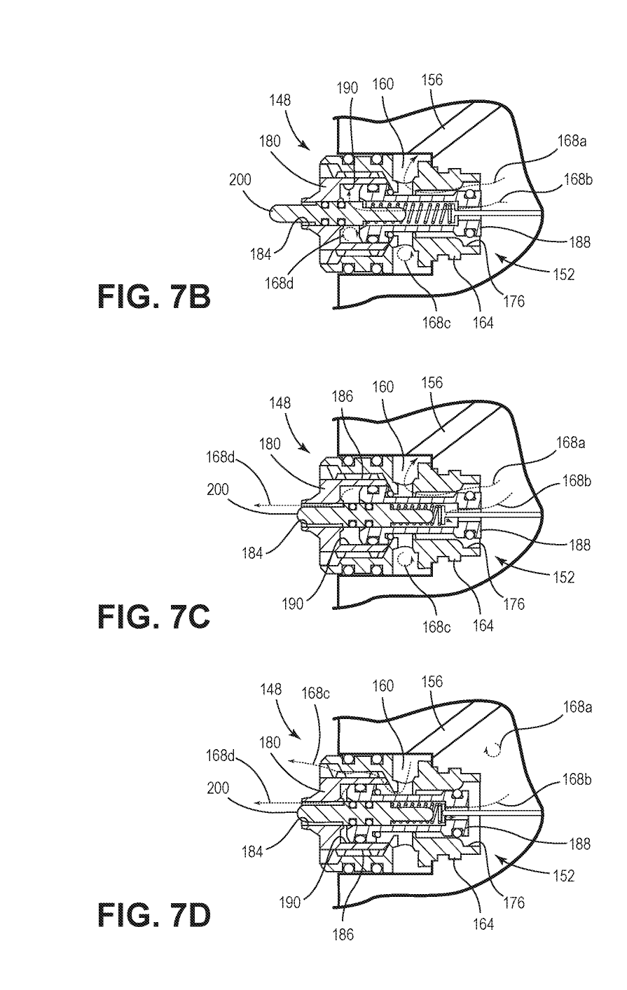

The fastener driver 110 also includes a trigger valve assembly 148 (see also FIGS. 7A-7D). High air pressure is released to atmosphere (i.e., atmospheric pressure) through the trigger valve assembly 148 when the activation trigger 130 is actuated, causing the head valve (not shown) to actuate and allowing compressed air stored in the handle portion 122 to drive the drive blade 28. The linkage 142 selectively inhibits the trigger valve assembly 148 from releasing high air pressure to atmosphere, as explained in further detail below.

With reference to FIGS. 6 and 7A, the trigger valve assembly 148 is supported by the handle portion 122 adjacent the activation trigger 130. The fastener driver 110 includes a first or air supply chamber 152 (FIG. 6), a main air passage 156, and a second or trigger air chamber 160 fluidly connecting the air supply chamber 152 and the main air passage 156. The trigger valve assembly 148 is housed within the trigger air chamber 160 and interposed between the air supply chamber 152 and the main air passage 156.

With reference to FIG. 7A, the trigger valve assembly 148 includes a valve body 164 having an air channel 168, which is fluidly connected to the main air passage 156 through radial ports 172 disposed in the valve body 164. The valve body 164 also includes a valve hole 176 that is in communication with the air supply chamber 152. The trigger valve assembly 148 further includes a valve base 180 coupled to the valve body 164. The valve base 180 includes a valve hole 184 and an exhaust groove 186, both of which are selectively communicable with atmosphere.

With continued reference to FIGS. 7A-D, the trigger valve assembly 148 further includes a valve plunger 188 capable of being reciprocately driven within the valve body 164 by compressed air from the air supply chamber 152. The valve plunger 188 is situated within the air channel 168 such that the air channel 168 is divided into a first air input passage (represented as arrow 168a) connecting the air supply chamber 152 and the trigger air chamber 160, a second air input passage (represented as arrow 168b) connecting the air supply chamber 152 and a third or valve air chamber 190 adjacent the valve hole 184 of the valve base 180, a first air exhaust passage (represented as arrow 168c) connecting the main air passage 156 and the exhaust groove 186 of the valve base 180, and a second air exhaust passage (represented as arrow 168d) connecting the chamber 190 via the valve hole 184 of the valve base 180 with atmosphere. The valve plunger 188 includes a through-hole 192 having a shoulder 196 disposed therein. The through-hole 192 connects the air supply chamber 152 with the valve hole 184 of the valve base 180 via the chamber 190.

The trigger valve assembly 148 further includes a valve stem 200 capable of being depressed upon actuation of the activation trigger 130. The valve stem 200 is nested and reciprocates between the valve hole 184 of the valve base 180 and the through-hole 192, such that the valve stem 200 selectively opens the valve hole 184 to atmosphere (i.e., second air exhaust 168d). That said, the valve stem 200 also selectively opens the through-hole 192 (i.e., second air input passage 168b). The trigger valve assembly 148 further includes a spring 204 disposed within the through-hole 192 abutting against the valve stem 200 and the shoulder 196. The spring 204 urges the valve stem 200 toward a default position (FIG. 6).

In operation, prior to the activation trigger 130 being actuated towards the depressed position, compressed air at high pressure is maintained within the air supply chamber 152. As shown in FIG. 7B, air from the supply chamber 152 is guided through the valve hole 176 of the valve body 164 along first air input passage 168a, and further into the trigger air chamber 160 and the main air passage 156. Simultaneously, the air from the supply chamber 152 is guided through the through-hole 192 along second air input passage 168b and into the valve air chamber 190, causing the pressure on opposite sides of the valve plunger 188 to be equal. At this point, the first and second exhaust passages 168c, 168d are inhibited from being discharged to atmosphere. Once the activation trigger 130 (and therefore the valve stem 200) is actuated to the depressed position, the valve air chamber 190 opens to atmosphere as air exits along the second air exhaust passage 168d (FIG. 7C), causing the valve plunger 188 to actuate (as shown in FIG. 7D) due to the pressure differential between opposite sides of the valve plunger 188. In other words, the pressure acting on the plunger 188 from the air supply chamber 152 is greater than the pressure acting the plunger 188 from the valve air chamber 190, causing the plunger 188 to reciprocate toward the lower-pressure region. After the plunger 188 actuates, the first air input passage 168a (FIG. 7D) is closed while high air pressure from the main air passage 156 escapes along first exhaust passage 168c, allowing the head valve (not shown) to actuate and causing the compressed air from the air supply chamber 152 to actuate the drive mechanism 29.

Without the safety trigger 138 being actuated, the linkage 142 remains engaged with the shoulder 196 of the plunger 188, thereby inhibiting the plunger 188 from being able to actuate as described above. Regardless that the pressure differential acting on the plunger 188, if the safety trigger 138 is not actuated, the linkage 142 mechanically interferes with the plunger 188, preventing the plunger 188 from actuating as described above. In this situation, compressed air in the first exhaust passage 168c is inhibited from escaping from the main air passage 156 to atmosphere, which is necessary for the drive mechanism 29 to actuate. Thus, the fastener driver 110 only operates when the safety trigger 138 (and therefore the linkage 142) is actuated in conjunction with actuation with the activation trigger 130.

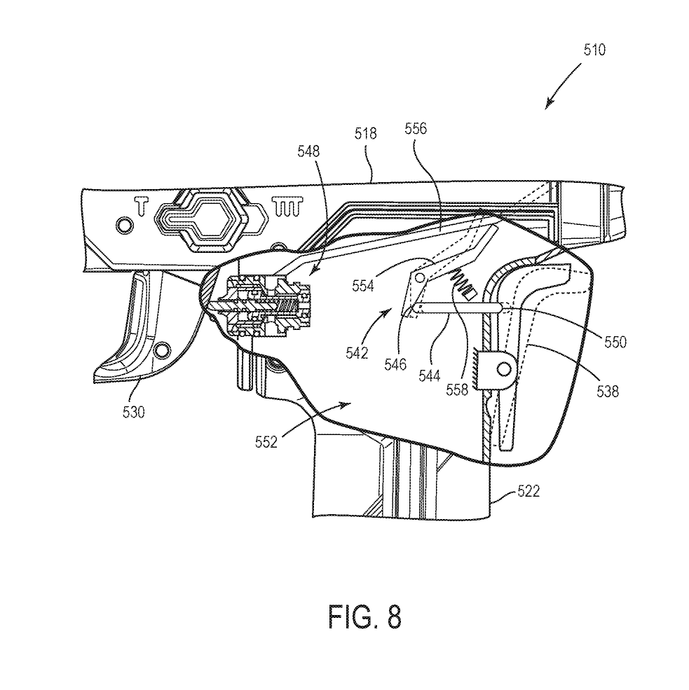

FIG. 8 illustrates a fastener driver 510 in accordance with another embodiment of the invention. The fastener driver 510 includes a linkage 542 movably coupled to a safety trigger 538 and is operable to inhibit a drive cycle, but is otherwise similar to the fastener driver 110 described above with reference to FIGS. 6-7D, with like components being shown with like reference numerals plus 400. Differences between the fastener drivers 110, 510 are described below.

The fastener driver 510 includes a housing 518 with a handle portion 522, a first or activation trigger 530, and a second or safety trigger 538. The activation trigger 530 and the safety trigger 538 are disposed adjacent and on opposite sides of the handle portion 522. Specifically, the activation trigger 530 is disposed on the front of the handle portion 522, while the safety trigger 538 is disposed on the rear of the handle portion 522. The activation trigger 530 is user-actuated to begin each drive cycle between a default position (FIG. 8) and a depressed position (not shown) to initiate the drive cycle. While the activation trigger 530 is actuated toward the depressed position by the user's fingers, the safety trigger 538 is actuated toward a depressed position (as shown in solid lines in FIG. 8) by the web of the user's hand as the user grasps the handle portion 522. The fastener driver 510 also includes a biasing element (e.g., a spring, not shown) for biasing the safety trigger 538 toward a default position (as shown in phantom lines in FIG. 8).

The linkage 542 is supported within the housing 518 and includes a rod member 544 having a first end 546 adjacent a main air valve 554 and an opposite, second end 550 adjacent the safety trigger 538. The first end 546 is maintained in sliding contact with main air valve 554, whereas the second end 550 is coupled to the safety trigger 538. The main air valve 554 is pivotable between a first position (as shown in phantom lines in FIG. 8) corresponding to the safety trigger 538 being in the default position and a second position (as shown in solid lines in FIG. 8) corresponding to the safety trigger 538 being in the depressed position. In the first position, the main air valve 554 substantially blocks airflow from escaping through the main air passage 556, whereas airflow is allowed to escape through the main air passage 556 when the main air valve 554 is in the second position. The main air valve 554 is biased toward the first position via a biasing element (e.g., a spring 558), while in other embodiments, the spring 558 may alternatively bias the safety trigger 538 toward the default position to accomplish the same effect.

In operation, prior to the activation trigger 530 being actuated towards the depressed position, compressed air at high pressure is maintained within the air supply chamber 552. Air from the supply chamber 552 is guided through the valve hole 176 of the valve body 164 along first air input passage 168a, and further into the trigger air chamber 160 and the main air passage 156 (refer again to FIGS. 7B-7D). Simultaneously, the air from the supply chamber 552 is guided through the through-hole 192 along second air input passage 168b and into the valve air chamber 190, causing the pressure on opposite sides of the valve plunger 188 to be equal. At this point, the first and second exhaust passages 168c, 168d are inhibited from being discharged to atmosphere. In the situation where the safety trigger 538 is actuated to the depressed position, the main air valve 554 pivots towards the second position to open the main air passage 556. By doing so, compressed air is able to escape through the main air passage 556 along first exhaust air passage 168c when the activation trigger 530 is actuated, permitting the fastener driver 510 to perform a fastener driving operation. Once the activation trigger 530 (and therefore the valve stem 200) is actuated to the depressed position, the valve air chamber 190 opens to atmosphere as air exits along the second air exhaust passage 168d, causing the valve plunger 188 to actuate due to the pressure differential between opposite sides of the valve plunger 188. After the plunger 188 actuates, high air pressure from the main air passage 556 escapes along first exhaust passage 168c, allowing the head valve (not shown) to actuate and causing compressed air from the air supply chamber 552 to actuate the drive mechanism 29.

In the situation where the safety trigger 538 remains in the default position, an operator may actuate the activation trigger 530 to the depressed position without initiating a drive cycle. Specifically, the main air valve 554 is in the first position when the safety trigger 538 is in the default position, substantially inhibiting compressed air to escape to atmosphere from air passage 556 along the second exhaust passage 168c. Without the second exhaust passage 168c effectively closed, the head valve (not shown) is unable to actuate and therefore compressed air from the air supply chamber 552 is unable to drive the drive mechanism 29. Thus, the fastener driver 510 only operates when the safety trigger 538 (and therefore the linkage 542) is actuated in conjunction with actuation of the activation trigger 530.

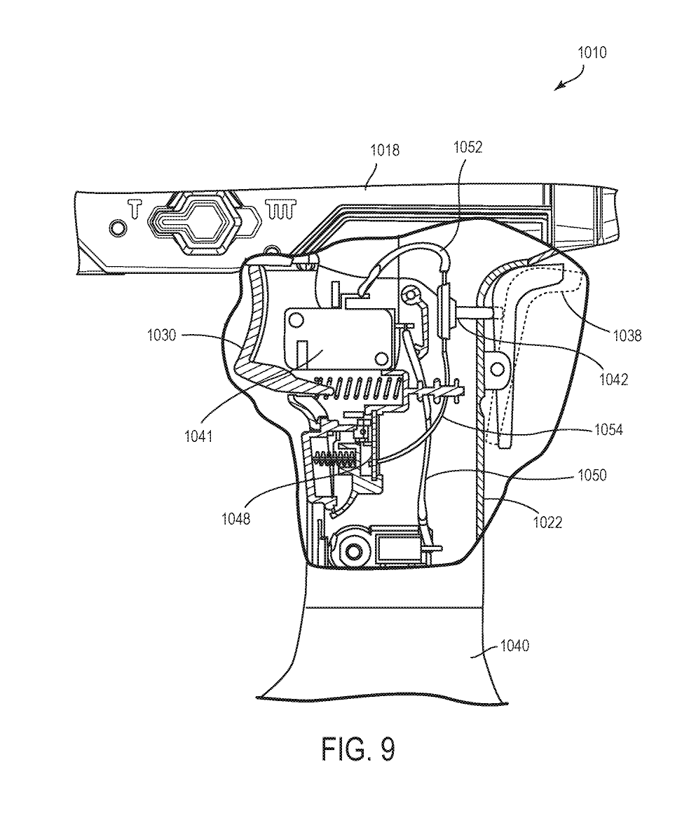

FIG. 9 illustrates a fastener driver 1010 in accordance with another embodiment of the invention. The fastener driver 1010 includes a safety switch 1042 coupled to a safety trigger 1038 and is operable to inhibit a drive cycle, but is otherwise similar to the fastener driver 10 described above with reference to FIGS. 1-5, with like components being shown with like reference numerals plus 1000. Differences between the fastener drivers 10, 1010 are described below.

With reference to FIG. 9, the fastener driver 1010 includes a housing 1018 with a handle portion 1022, a first or activation trigger 1030, and a second or safety trigger 1038. The fastener driver 1010 of this particular embodiment is a battery-powered nailer such that the driver 1010 includes a battery 1040 operable to selectively supply power to an on-board air compressor (not shown). Thus, the driver 1010 does not require an external source of air pressure, but rather uses the on-board air compressor to actuate the drive mechanism 29. Alternatively, the battery 1040 of the fastener driver 1010 could be used to power an on-board reciprocating piston to create a vacuum, which could be used for driving a drive piston and an attached drive blade, or an on-board reciprocating piston to compress a fixed amount of gas on-board the driver 1010, the stored energy from which could be used for driving a drive piston and an attached drive blade.

The activation trigger 1030 and the safety trigger 1038 are disposed adjacent and on opposite sides of the handle portion 1022. Specifically, the activation trigger 1030 is disposed on the front of the handle portion 1022, while the safety trigger 1038 is disposed on the rear of the handle portion 1022. The activation trigger 1030 is user-actuated to begin each drive cycle between a default position (FIG. 9) and a depressed position (not shown) to initiate the drive cycle. While the activation trigger 1030 is actuated toward the depressed position by the user's fingers, the safety trigger 1038 is actuated toward a depressed position (as shown in solid lines in FIG. 9) by the web of the user's hand as the user grasps the handle portion 1022. The fastener driver 1010 also includes a biasing element (e.g., a spring, not shown) for biasing the safety trigger 1038 toward a default position (as shown in phantom lines in FIG. 9).

With continued reference to FIG. 9, the safety switch 1042 is capable of generating a first trigger input in response to the safety trigger 1038 being depressed, while a activation switch 1041 is capable of generating a second trigger input in response to the activation trigger 1030 being depressed. Both the activation trigger 1030 and the safety trigger 1038 are disposed within the handle portion 1022 adjacent the corresponding trigger 1030, 1038.

The fastener driver 1010 further includes a master controller 1048 disposed within the handle portion 1022. The master controller 1048 is capable of electrically communicating with the activation switch 1041 and the safety switch 1042 to selectively permit a drive cycle to be initiated. The master controller 1048 is operable to accept the first trigger input from the safety switch 1042 and the second trigger input from the activation switch 1041. Upon detecting both the first trigger input and the second trigger input, the master controller 1048 may initiate a drive cycle. Without first receiving the first trigger input from the safety trigger 1042, the controller 1048 will not allow a drive cycle to initiate.

As shown in FIG. 9, the activation switch 1041 is electrically coupled to the battery 1040 via a first wire 1050. The activation switch 1041 is also electrically coupled to the safety switch 1042 via a second wire 1052. The master controller 1048 is electrically coupled to the safety switch 1042 via a third wire 1054. The battery 1040, the activation switch 1041, the safety switch 1042, and the master controller 1048 are arranged in series such that the master controller 1048 electrically interfaces with the activation switch 1041 via the safety switch 1042. Activating the safety switch 1042 in conjunction with the activation switch 1041 completes a circuit between the master controller 1048 and the battery 1040 to selectively permit a drive cycle to be initiated.

In operation, a user depresses the safety trigger 1038 and the activation trigger 1030 to activate (i.e., close) the safety switch 1042 and the activation switch 1041, respectively, which provides a voltage input to the controller 1048. Upon receiving this voltage input, the controller 1048 activates the drive mechanism 29 to initiate a drive cycle.

Various features of the invention are set forth in the following claims.

What is claimed is:

1. A powered fastener driver comprising:
a magazine containing fasteners therein;
a drive blade movable in a reciprocating manner to discharge a fastener from the magazine for each drive cycle of the drive blade;
a first trigger operable to initiate a drive cycle of the drive blade; and
a second trigger movable between a first position, in which initiation of the drive cycle is inhibited irrespective of actuation of the first trigger, and a second position, in which initiation of the drive cycle occurs in conjunction with actuation of the first trigger.

2. The powered fastener driver of claim 1, further comprising a valve assembly operable to selectively initiate the drive cycle.

3. The powered fastener driver of claim 2, wherein the valve assembly is coupled to and actuatable in response to movement of the first trigger, and wherein the drive cycle is initiated upon the valve assembly being actuated.

4. The powered fastener driver of claim 2, further comprising a linkage extending between the second trigger and the valve assembly, wherein the linkage is responsive to movement of the second trigger.

5. The powered fastener driver of claim 4, wherein the linkage includes a first end adjacent the second trigger and an opposite, second end adjacent the valve assembly.

6. The powered fastener driver of claim 5, wherein the second end of the linkage includes a shoulder that is received within the valve assembly.

7. The powered fastener driver of claim 6, wherein the valve assembly includes a valve plunger reciprocately driven within the valve assembly, wherein the shoulder of the linkage is engaged with the valve plunger.

8. The powered fastener driver of claim 7, wherein the shoulder is engaged with the valve plunger when the second trigger is in the first position, thereby preventing movement of the valve plunger to initiate a drive cycle.

9. The powered fastener driver of claim 8, wherein the shoulder is spaced from the valve plunger when the second trigger is in the second position, thereby permitting movement of the valve plunger to initiate a drive cycle.

10. The powered fastener driver of claim 4, wherein the linkage is moveable relative to the first trigger in unison with the second trigger.

11. The powered fastener driver of claim 4, wherein the linkage is translatable in response to pivoting movement of the second trigger.

12. The powered fastener driver of claim 2, wherein the valve assembly is pivotable between a first position when the second trigger is in the first position and a second position when the second trigger is in the second position.

13. The powered fastener driver of claim 12, further comprising a spring biasing the valve assembly toward the first position.

14. The powered fastener driver of claim 13, further comprising a linkage extending between the second trigger and the valve assembly, and wherein the linkage is maintained in sliding contact with the second trigger by the spring.

15. The powered fastener driver of claim 1, further comprising a safety switch coupled to the second trigger and an activation switch coupled to the first trigger, wherein the safety switch is capable of generating a first trigger input in response to the second trigger being depressed, and the activation switch is capable of generating a second trigger input in response to the activation trigger being depressed.

16. The powered fastener driver of claim 15, further comprising a master controller capable of electrically communicating with the activation switch and the safety switch to selectively permit the drive cycle to be initiated, wherein the master controller initiates the drive cycle when both the first trigger input and the second trigger input are detected.

17. The powered fastener driver of claim 1, wherein the first trigger is configured to be actuated by the fingers of an operator's hand, and wherein the second trigger is configured to be actuated by the web of the same hand.

18. A method of operating a powered fastener driver, the method comprising:
providing a first trigger operable to initiate a drive cycle of a drive blade of the fastener driver;
actuating a second trigger from a first position to a second position; and
then, actuating the first trigger to initiate the drive cycle of the drive blade.

19. The method of claim 18, further comprising:
disengaging a linkage from a valve assembly in the fastener driver in response to actuation of the second trigger from the first position to the second position; and
in response to actuating the first trigger, opening a passageway in the valve assembly to initiate the drive cycle.

20. The method of claim 19, further comprising pivoting the valve assembly in response to actuation of the second trigger to allow initiation of the drive cycle.

21. The method of claim 18, further providing a safety switch coupled to the second trigger and an activation switch coupled to the first trigger.

22. The method of claim 21, further comprising generating a first trigger input via the safety switch in response to the second trigger being depressed and generating a second trigger input via the activation switch in response to the first trigger being depressed.

23. The method of claim 22, further comprising detecting the first trigger input and the second trigger input with a master controller to permit the drive cycle to be initiated.
